(19) United States
(12) Patent Application Publication
(10) Pub. No.: US 2002/0069078 A1
(43) Pub. Date: Jun. 6, 2002

(54) System and method for creating custom wallpaper

(76) Inventor: Jaclyn R. Goldstein, Atlanta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/865,183

(22) Filed: May 24, 2001

Related U.S. Application Data
(60) Provisional application No. 60/207,055, filed on May 25, 2000.

(51) Int. Cl. G06F 17/60

(52) U.S. Cl. 705/1

(57) ABSTRACT

A computerized system and method for creating and delivering custom wallpaper. The system comprises a custom wallpaper creation program module and a printing module. The custom wallpaper creation program module is operable for displaying a selection of wallpaper design parameters on a website, operable for receiving a user selection of wallpaper design parameters, and further operable for displaying one or more selected wallpaper design parameters. The printing module is operable for receiving selected wallpaper design parameters from a custom wallpaper creation program module, operable for formatting the parameters for printing a corresponding design characteristic on a sheet of wallpaper, and further operable for printing the corresponding design characteristic on a sheet of wallpaper. The present invention can include a database for storing previously created wallpaper design parameters or for storing user-selected wallpaper design parameters.

### FIELD OF THE INVENTION

The present invention relates in general to custom wallpaper to be applied to walls. More particularly, the present invention relates to a computerized system and method for creating and delivering custom wallpaper.

### BACKGROUND OF THE INVENTION

Traditionally, wallpaper is an “off-the-shelf” product that is limited to colors, designs, and patterns of a manufacturer's choice. A consumer desiring a particular color, design, or pattern typically did not have the option of creating custom wallpaper. Most people do not have the creative ability, resources, or access to the expensive design and printing equipment needed to design and create custom wallpaper. For example, if a consumer wants a specific design of wallpaper that cannot be obtained from “off-the-shelf” sources, the consumer must deal directly with a specialty designer and manufacturer to design, create, and obtain the specific wallpaper design. The wallpaper manufacturer must then take the time to create a design template which can include particular colors, designs, or patterns in accordance with the consumer's desired preferences. A specialized wallpaper design created by the wallpaper manufacturer is only used for the consumer's specific order and results in waste if the design is never used again. The effort and time that both the consumer and the wallpaper manufacturer expend in creating a specialized template for a single order of wallpaper creates wasted resources for both the consumer and the wallpaper designer and manufacturer, making custom wallpaper virtually unaffordable for the mainstream consumer. Creating and delivering custom wallpaper can be a complicated, time consuming, and expensive task. Thus, there is a need for a system and method for creating custom wallpaper.

### SUMMARY OF THE INVENTION

The present invention is a system and method for creating custom wallpaper. The present invention can include one or more custom wallpaper creation program modules operating on the server and/or remote devices. Generally, the present invention operates in a distributed computer network environment including a server and one or more remote devices. A user may interact with the present invention through a remote device in communication with the network, or otherwise through an input device in communication with the network. Previously existing wallpaper design parameters can be stored in a database that is accessible by one or more custom wallpaper creation program modules. Each custom wallpaper creation program module can be operable for displaying a selection of design parameters on a website via a remote device and/or display device. The user can interact through a graphical user interface such as an Internet website to select wallpaper design parameters presented to the user on the remote device and/or display device.

The present invention can also include a printing module associated with a printing service provider. The printing module can be stored on the server and/or one or more remote devices. In either case, the printing module can communicate with the network. The printing module is operable for receiving selected wallpaper design parameters from a custom wallpaper creation program module, operable for formatting the wallpaper design parameters for printing a corresponding design characteristic on a medium such as wallpaper, and further operable for printing the corresponding design characteristic on a medium such as a sheet of wallpaper.

Furthermore, the present invention can include a database that can be stored on the server and/or remote devices. The database can be in communication with the network. The database is operable for storing previously defined wallpaper design parameters for selection by a user, operable for storing user-selected wallpaper design parameters, and further operable for transmitting user-selected design parameters to the printing module.

In another embodiment, the present invention can operate in a remote device such as a personal computer installed in a kiosk. A user may interact with the present invention through the remote device, or otherwise through an input device associated with a remote device. One or more custom wallpaper creation program modules can then display a selection of design parameters on the remote device and/or display device. The user can interact through a graphical user interface on the remote device or display device to select wallpaper design parameters. The custom wallpaper creation program modules can then store user-selected wallpaper design parameters for later retrieval or printing by a printing module.

When a user operates the present invention, the custom wallpaper creation program module displays a selection of previously stored wallpaper design parameters via a remote device and/or display device. When the user makes a selection of a particular wallpaper design parameter using an input device or remote device, the custom wallpaper creation program module receives the user selection of at least one wallpaper design parameter. The custom wallpaper creation program module then permits the user to view the selected wallpaper design parameter on the remote device and/or display device. When the user is satisfied with a particular selection, or is otherwise finished selecting a wallpaper design parameter, the custom wallpaper creation program module transmits the selected wallpaper design parameter to the printing module where the wallpaper design parameter is formatted for printing a corresponding design characteristic on a sheet of wallpaper.

Wallpaper design parameters can include, but are not limited to, graphic objects, designs, patterns and repeat patterns, border trim, backgrounds including background color and textures, photographic images, illustrations, clip art, fonts, text, typeface, colors, etc.

### BRIEF DESCRIPTION OF THE DRAWINGS

FIG. 1 is a functional block diagram illustrating an exemplary embodiment of the present invention that is configured for facilitating the creation and delivery of custom wallpaper in a networked computer environment.

FIG. 2 is an exemplary method of an embodiment of the present invention.

FIG. 3 is an exemplary subroutine of another embodiment of the present invention.

FIG. 4 is a screen shot of an introductory webpage or homepage of a website that operates in conjunction with an exemplary embodiment of the present invention.

FIG. 5 is a screen shot of a creation webpage of a website that operates in conjunction with an exemplary embodiment of the present invention.

FIG. 6 is a screen shot of another creation webpage of a website that operates in conjunction with an exemplary embodiment of the present invention.

FIG. 7 is a screen shot of another creation webpage of a website that operates in conjunction with an exemplary embodiment of the present invention.

FIG. 8 is a screen shot of another creation webpage of a website that operates in conjunction with an exemplary embodiment of the present invention.

FIG. 9 is a screen shot of a another creation webpage of a website that operates in conjunction with an exemplary embodiment of the present invention.

FIG. 10 is an illustration of a wallpaper design sample created by an exemplary embodiment of the present invention.

### DETAILED DESCRIPTION OF EMBODIMENTS OF THE INVENTION

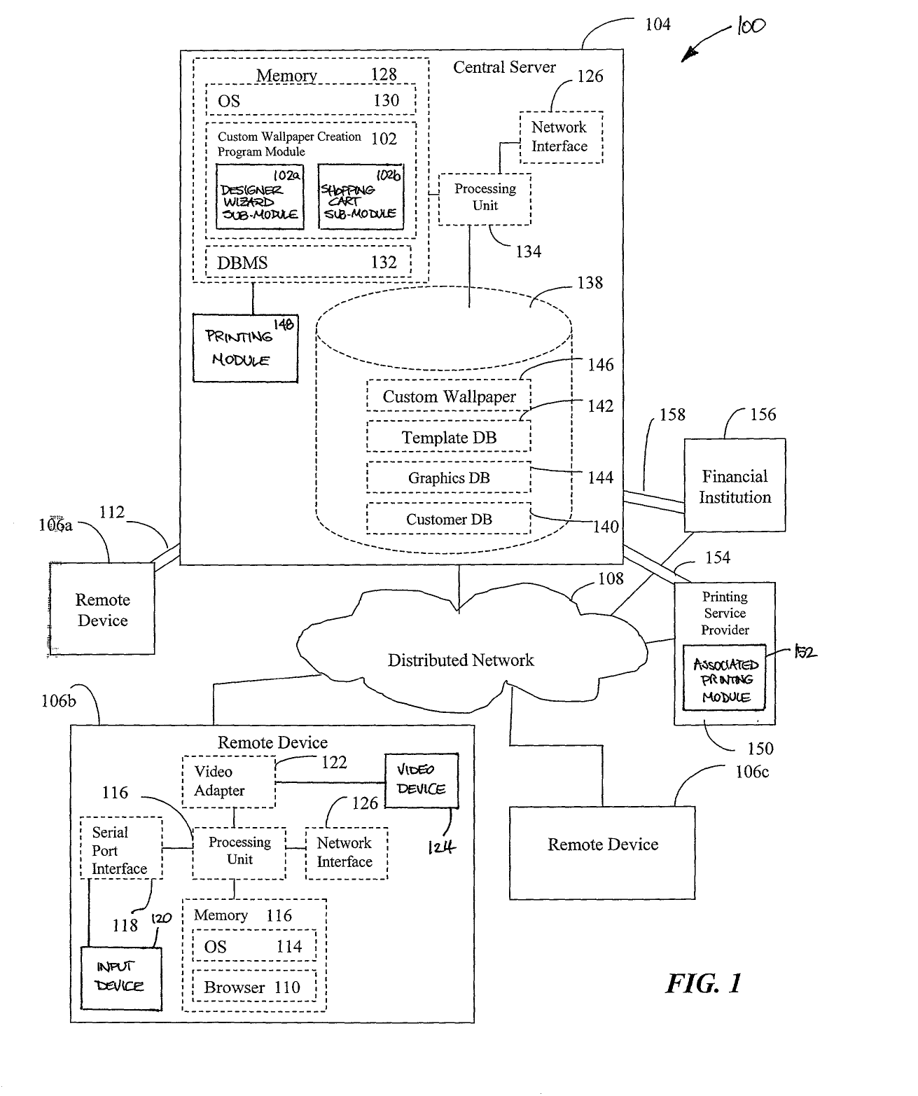

Particular embodiments of the present invention will now be described in greater detail with reference to the drawings. FIG. 1 shows a functional block diagram illustrating an exemplary embodiment of the present invention that is configured for facilitating the creation and delivery of custom wallpaper in a networked computer environment 100. As shown, the present invention includes one or more of the exemplary custom wallpaper creation program modules 102 for facilitating the creation and delivery of custom wallpaper. Each custom wallpaper creation program module 102 can comprise one or more sub-modules 102a-b operable for methods or subroutines for facilitating the creation and delivery of custom wallpaper. The custom wallpaper creation program modules 102 and respective sub-modules 102a-b may be configured for execution by a central server 104 that is accessible by a remote device 106a-c via a distributed computer network 108, such as the Internet. Moreover, a custom wallpaper creation program module 102 can comprise a website 109 for interacting with a user via a network such as the Internet.

Typically, a custom wallpaper creation program module 102 comprises computer-executable instructions for facilitating the process of creating custom wallpaper. The custom wallpaper creation program module 102 may comprise a designer wizard sub-module 102a that is operable to access and to display an electronic database or catalog of customizable template designs and an assortment of sample rooms. The designer wizard sub-module 102a may be further operable to permit user selection of previously stored or newly created wallpaper design parameters, such as those stored in a database or downloaded from a remote location. Furthermore, the designer wizard sub-module 102a may be operable to display selected wallpaper design parameters for the user to view a sample design of custom wallpaper. Moreover, the designer wizard sub-module 102a may be operable to permit creation of specific wallpaper design elements for use as wallpaper design parameters.

A custom wallpaper creation program module 102 may also comprise a shopping cart sub-module 102b that prompts and assists the user in calculating wall dimensions and a quantity of wallpaper needed or desired. Each of the custom wallpaper creation program modules 102, and associated sub-modules 102a-b may be accessible to a user via the Internet through a website 109.

A remote device 106a-c may comprise a desktop computer, a laptop computer, a hand-held device, a personal digital assistant, a kiosk, or the like. A remote device 106a-c may be configured for execution of a browser program 110 in order to view the website 109 and interact with the custom wallpaper creation program modules 102 at the central server 104. The remote device 106a-c may communicate with the server 104 via any well-known communications link, such as a local area network, a wide area network, the Internet, etc. For example, the communications link 112, or at least a portion thereof, may be a wireless network.

In some cases, the remote device 106a-c may be configured for executing one or more custom wallpaper creation program modules 102. Alternatively, the remote device 106a-c can communicate with a server 104 or server computer, which executes the one or more custom wallpaper creation program modules 102. In other cases, both the remote device 106a-c and the server 104 may execute one or more custom wallpaper creation program modules 102.

In general, a remote device 106b may comprise a memory for storing such things as an operating system 114, a browser program 110 or other program modules or data files, and a processing unit 116 for executing application programs, such as the browser program 110. The remote device 106b may also comprise a serial port 118 for communication with one or more input devices 120 such as a keyboard and a mouse, a video adapter 122 for communication with a display device 124, and a network interface 126 for communication with the distributed computer network 108 or a dedicated communications link 112. The input device may be connected to the remote device 106a-c or may be connected to the network 108. As will be apparent to those of skill in the art, a remote device 106b may comprise additional features and components.

The central server 104 may also comprise a conventional computer system configured to function as a network server. For example, the central server 104 may comprise a memory 128 for storing an operating system 130, one or more custom wallpaper creation program modules 102, a database management system (DBMS) 132, as well as other program modules and data files. The central server 104 may further comprise a processing unit 134 and a network interface 136. The central server 104 may also comprise or be in communication with a database 138 for storing data relating to the creation of custom wallpaper.

The database 138 may comprise a customer database 140, a template database 142, a graphics database 144, and a custom wallpaper database 146. The customer database 140 is operable for storing customer-specific data, e.g., demographic, financial, and purchase history data. Demographic data can include, but is not limited to, customer address information, customer or user preferences, and a profile of customer interests. Financial data can include, but is not limited to, credit card information, account information, and financial institution information. Purchase history data can include, but is not limited to, the number of previous purchases, the dates and times of previous purchases, and the cost or prices paid for previous purchases.

The template database 142 is operable for storing a plurality of custom wallpaper templates with wallpaper design parameters. Custom wallpaper templates can include, but are not limited to, those previously made by the user, templates designed by a third-party, or those designed by a commercial wallpaper designer and manufacturer.

The graphics database 144 is operable for storing data files relating to other wallpaper design parameters. Data files relating to other wallpaper design parameters can include, but are not limited to, files for graphic objects, designs, patterns and repeat patterns, border trim, backgrounds including background color and textures, photographic images, illustrations, clip art, fonts, text, typeface, and colors.

The custom wallpaper database 146 is operable for storing finalized custom wallpaper designs. Finalized custom wallpaper designs can include, but are not limited to, designs created by a user, designs previously created by a third-party, or designs created by a commercial wallpaper designer and manufacturer.

Each of the databases 140-146 can be linked together so that information can be shared between each of the databases, or otherwise accessed collectively when needed. For example, information about a particular customer may be stored in the customer database 140, and wallpaper images or templates created by the customer may be stored in a custom wallpaper database 146. If a user desires to store custom wallpaper images or templates for later retrieval from the system 100, then the user can locate the particular custom wallpaper images or templates at a later time.

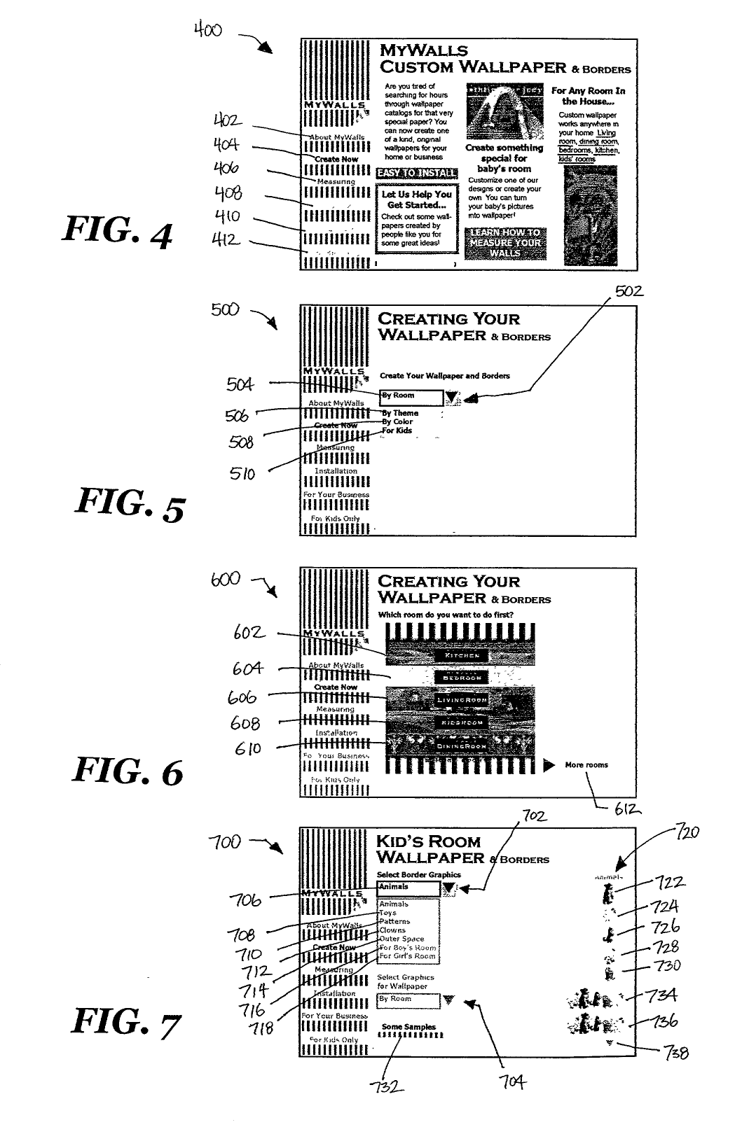

Generally, the custom wallpaper creation program modules 102 at the central server 104 may be accessed from a remote device 106a-c via the distributed computer network 108, by way of a website 109. The website 109 may display to a user a series of forms or webpages designed to facilitate the entry of input data for the creation of custom wallpaper. A set of sample forms or webpages will be described in greater detail in conjunction with FIGS. 4-9.

A user may interact with one or more sub-modules 102a -c of the custom wallpaper creation program modules 102 in order to design and purchase custom wallpaper. For example, a designer wizard sub-module 102a can present a list of available wallpaper templates and associated wallpaper design parameters to the user. The designer wizard sub-module 102a can present one or more webpages that prompt and assist the user to select wallpaper design parameters to create a sample design of custom wallpaper. The user can control selections by way of the input device 120 such as selecting a wallpaper template and various wallpaper design parameters. The user can also use the input device 120 to place wallpaper design parameters or elements, select colors from a color palette, select fonts, backgrounds and other wallpaper design parameters or elements to personalize or customize a wallpaper template to match their desired decor. To facilitate a wallpaper custom design, the user may also download previously stored, newly created, or new digital images to the central server 104. Selected input data and images transferred by the user to the central server 104 may be also imported into a wallpaper template for further creation and design of custom wallpaper. Those skilled in the art should appreciate that input data and images may be downloaded to the central server 104 from the remote device 106a-c in a batch mode, or in an interactive mode. Custom wallpaper creation program modules 102 may also allow the user to create a custom design for wallpaper without the use of any pre-prepared templates, instead, creating all original materials.

When a user makes a selection of data or of wallpaper design parameters, the custom wallpaper creation program modules 102 or designer wizard sub-module 102a can display the input data or selections by way of the display device 124 so that the user can create, manipulate, and view a sample design of custom wallpaper. The sample design of custom wallpaper can be further modified by the user to suit the user's desired decor.

After a user selects input data or wallpaper design parameters, the selected input data or wallpaper design parameters can be stored in the database 138 for later retrieval. These selected data and parameters can be also be accessed by the central server 104 or by one or more other databases 140-146 when needed.

The custom wallpaper creation program modules 102 may provide the user with the option to view a sample of the custom wallpaper. For example, as the user selects a desired wallpaper design parameter, the custom wallpaper creation program module 102 can create a sample design of all selected wallpaper design parameters for viewing by the user on a display device.

When the design of the custom wallpaper has been completed, the sample design may be saved to a data file in an electronic format. For example, a finalized custom wallpaper design may be stored in a data file in the custom wallpaper database 146. Conventional methods and techniques for storing data in an electronic format can be utilized for a data file containing a sample design of custom wallpaper.

During the design process, the user may be provided with the ability to communicate, for example via electronic mail, with a design consultant. A data file containing the user's sample design of custom wallpaper can also be shared with a design consultant via electronic mail should the user seek additional design guidance.

The design sample may be printed to any printer that is in communication with the remote device 106a-c (e.g., a printer coupled to a kiosk) or the server. Typically, the custom wallpaper creation program modules 102 translate any user selections, such as input data or user-selected wallpaper design parameters, into an appropriate language, such as postscript, that can be stored in electronic format and is readable by a digital printing press. The digital printing press may comprise a digital ink-jet or laser printer. The digital printing press may be configured to print the custom wallpaper onto a medium. A suitable medium can be a laminated sheet of paper stock with adhesive backing. However, the medium such as paper stock may or may not be laminated, and furthermore may or may not have an adhesive backing. Alternately, the custom wallpaper design may be printed onto other substrates, such as fabrics, plastics, composites, ceramics, etc.

The central server 104 may comprise hardware and software components, such as a printing module 148 for printing professional versions of custom wallpaper using user-selected wallpaper design parameters. Alternatively, the central server 104 may communicate with a printing service provider 150 comprising an associated printing module 152, in which the associated printing module 152 can communicate with the server 104 via the distributed network 108 or a private communications link 154. The printing service provider 150 may thus be maintained or controlled by the same entity that maintains or controls the central server 104, or the printing service provider 150 may be an independent entity. The printing service provider 150 connects to the distributed computer network 108, and is in communication with the custom wallpaper creation program module 102 and the database 138. The printing service provider 150 can comprise a printing module 148 which can access a digital printing press, digital ink-jet, laser printer, or similar type of printing equipment. The printing module 148 can receive information from the custom wallpaper creation program module 102 and the database 138 such as data files containing finalized custom wallpaper designs. After the custom wallpaper is printed, it may be shipped directly to the user, to a retail location, or to a professional installer.

Furthermore, the central server 102 may accept payment for the custom wallpaper from the user by way of any well-known electronic funds transfer mechanism. When a wallpaper design has been completed and approved by a user, the user can make a wallpaper purchase through the custom wallpaper creation program modules 102 or electronic shopping cart sub-module 102b via an electronic funds transfer. A typical electronic funds transfer involves transmittal of a financial account number (e.g., a credit card or debit card account number) via a secured website. The central server and the printing service provider 175 may also perform settlement via electronic funds transfer, if appropriate. For example, the central server 104 may communicate with a financial institution 156 or a point-of-sale device via the distributed network 106 or a dedicated communications link 158. A remote device 106a-c may provide the user with the ability to input financial account information (e.g., credit card information, debit card information, etc.) in order to make an electronic purchase. The financial account information may be transmitted to the server 104, which may communicate with a financial institution 156. The server 104, or the operator thereof, may thus use the financial information received from the user to complete a transaction. In some instances, feedback or user-specific information can be received by the server from the financial institution 156. The custom wallpaper creation program modules 102 or electronic shopping cart sub-modules 102b can then utilize the feedback or user-specific information and user's financial information to facilitate, to evaluate, or to complete an order or other type of transaction with a user.

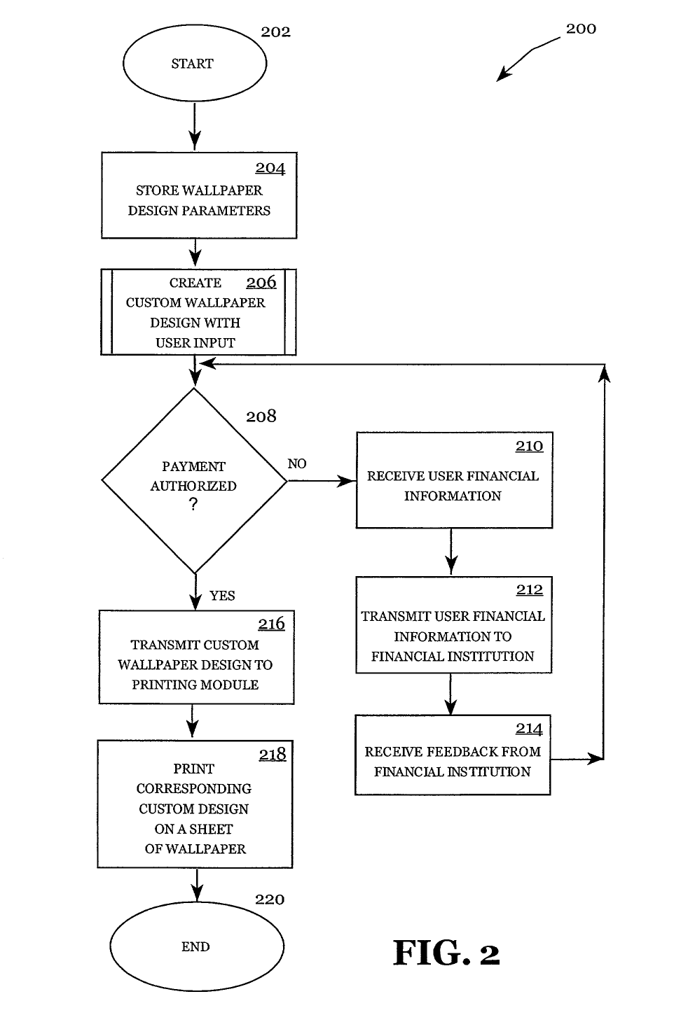

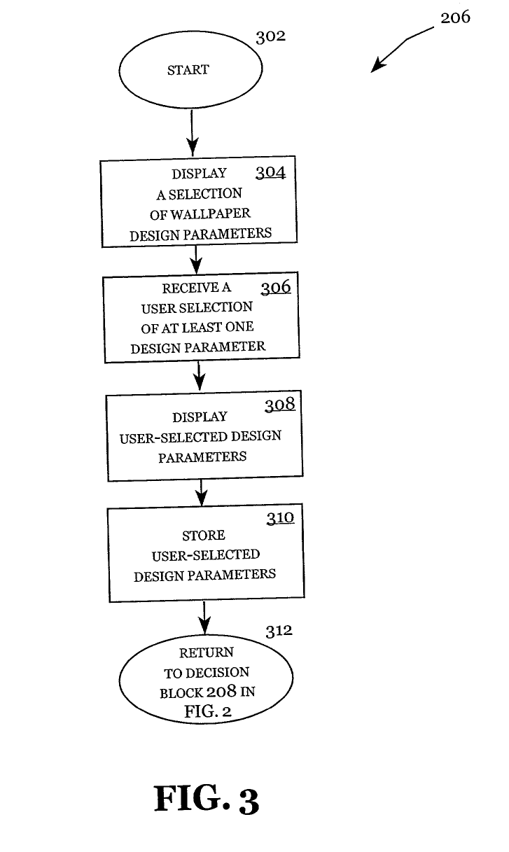

FIG. 2 is an exemplary method of an embodiment of the present invention for creating custom wallpaper via a distributed computer network environment. The method 200 starts at step 202.

Step 202 is followed by step 204, in which a selection of wallpaper design parameters is stored. A selection of wallpaper design parameters can be stored by one or more custom wallpaper creation program modules 102. Typically, a selection of wallpaper design parameters can be stored in a database or in a similar type of memory-based device, and can be accessed by the custom wallpaper creation program modules 102. Wallpaper design parameters can include, but are not limited to, wallpaper elements, wallpaper colors from a color palette, typographical fonts, backgrounds and other elements to personalize or customize wallpaper templates. Generally, a wallpaper design parameter is associated with a particular wallpaper design characteristic. Step 204 is followed by subroutine 206, in which a custom wallpaper design is created with user input. For example, a designer wizard sub-module 102a can execute the steps of subroutine 206. Subroutine 206 is further described with reference to the flowchart depicted in FIG. 3. Typically, a user can interact with one or more custom wallpaper creation program modules 102 through a website 109 via a remote device 106a-c or an input device 120. The user can select one or more wallpaper design parameters to create a custom order of wallpaper. Furthermore, the user can create a custom order of wallpaper utilizing new wallpaper design parameters or previously existing or stored wallpaper design parameters. The custom wallpaper creation program modules 102 can then compile the user-selected wallpaper design parameters into a sample custom wallpaper design.

Subroutine 206 is followed by decision block 208, in which a determination is made whether payment is authorized. That is, after a sample custom wallpaper design is complete or approved by a user, the custom wallpaper creation program modules 102 can determine whether the user is authorized to ultimately purchase the sample custom wallpaper design.

If the custom wallpaper creation program modules 102 determine that the user not authorized, then the “NO” branch is followed to step 210. In step 210, one or more of the custom wallpaper creation program modules 102 receives financial information about the user. This financial information can be input by a user through a series of formatted webpages on the website 109, or can be otherwise previously stored information in an associated database 138 accessible by one or more of the custom wallpaper creation program modules 102.

Step 210 is followed by step 212, in which one or more custom wallpaper creation program modules 102 transmits a user's financial information to a financial institution 156.

Step 212 is followed by step 214, in which one or more custom wallpaper creation program modules 102 receive feedback from the financial institution 156. Typically, feedback from the financial institution 156 can include an authorization to permit the user to purchase the sample custom wallpaper design, settlement of a purchase transaction, transfer of electronic funds to an account, or the establishment of a line of electronic credit. In some cases, a user will be given negative feedback, and a decision can be made to end the user's attempted purchase or transaction.

After step 214, the method 200 returns to decision block 208.

If the custom wallpaper creation program modules 102 determine that the user is authorized, then the “YES” branch is followed to step 216. Based upon feedback from the financial institution, one or more custom wallpaper creation program modules 102 can authorize the user to complete the transaction and the method 200 continues.

In step 216, one or more custom wallpaper creation program modules 102 transmit user-selected wallpaper design parameters to a printing module 148. The printing module can be associated with the custom wallpaper creation program modules 102 or can be associated with an independent printing service provider 150. The custom wallpaper creation program modules 102 can retrieve previously stored user-selected wallpaper design parameters from an associated database 138 and transmit these parameters to a printing module 148. Typically, the wallpaper design parameters have been saved in an electronic format that can be utilized by a digital printer, or similar type of printing device.

Step 216 is followed by step 218, in which a corresponding custom wallpaper design is printed onto a medium. A suitable medium can be a laminated sheet with adhesive backing. Typically, the printing module receives the user-selected wallpaper design parameters and the parameters are sent to a digital printer or similar type of printing device. The digital printer or other type of printing device formats the user-selected wallpaper design parameters, and then corresponding custom wallpaper design can be printed. Generally, the corresponding custom wallpaper design is characterized by the user-selected wallpaper design parameters.

FIG. 3 illustrates an exemplary subroutine of an embodiment of the present invention for creating custom wallpaper via a distributed computer network environment. For example, a designer wizard sub-module 102a can execute the steps of subroutine 206. The subroutine 206 starts at step 302.

Step 302 is followed by step 304, in which a selection of wallpaper design parameters is displayed. A selection of wallpaper design parameters can be displayed by one or more custom wallpaper creation program modules 102 via a remote device 106a-c or on an associated display device 124 connected to a remote device 106a-c. The selection of wallpaper design parameters can be previously stored in a database 138 or in a similar type of memory-based device, and can be further accessed by the custom wallpaper creation program modules 102. As discussed previously, wallpaper design parameters can include, but are not limited to, wallpaper elements, wallpaper colors from a color palette, typographical fonts, backgrounds and other elements to personalize or customize wallpaper templates. Generally, a wallpaper design parameter is associated with a particular wallpaper design characteristic.

Step 304 is followed by step 306, in which at least one design parameter is received from a user. Typically, a user can interact with the custom wallpaper creation program modules 102 via a website 109 or through a remote device 106a-c to select one or more wallpaper design parameters in order to create or to customize wallpaper. Sometimes, a remote device 106a-c will provide the user with an input device 120 to interact with the wallpaper creation program modules 102 in order to select one or more wallpaper design parameters in order to create or to customize wallpaper.

Step 306 is followed by step 308, in which the user-selected wallpaper design parameters are displayed. After a user selects a particular design parameter, the custom wallpaper creation program modules 102 can display the user's selection on a remote device 106a-c or associated display device 124. The custom wallpaper creation program modules 102 can retrieve previously stored user-selected wallpaper design parameters from a database or other memory or storage-type device, and process these parameters for visual display of a sample design of wallpaper in accordance with design characteristics corresponding to the user-selected design parameters.

Step 308 is followed by step 310, in which the user-selected wallpaper design parameters are stored for later retrieval. In general, all of the user-selected design parameters for use in a final sample design of custom wallpaper are translated into an electronic format that can be used by a printing module 148. The user-selected wallpaper design parameters are then stored in a database 138 for later retrieval by one or more of the custom wallpaper creation program modules 102 or by the printing module 148.

Alternatively, all of the user-selected wallpaper design parameters stored for later retrieval do not have to be selected in a single user design session. A user may create a particular wallpaper design today, create dimensions for the wallpaper design on another day, and then purchase the wallpaper design next week. The storage of user-selected parameters in the database 138 permits the user to revisit the website when needed to complete a custom wallpaper design and subsequent purchase when desired.

After step 310, the subroutine 206 returns to decision block 208 in FIG. 2.

FIGS. 4-9 illustrate exemplary forms and webpage screen shots of a website 109 that operates in conjunction with an exemplary embodiment of the present invention. FIG. 4 is a screen shot of an introductory webpage or homepage 400 of a website that operates in conjunction with an exemplary embodiment of the present invention. One or more of the exemplary custom wallpaper creation program modules 102 can present a homepage 400 on a website for facilitating the creation and delivery of custom wallpaper. The homepage 400 can present one or more user options 402-412 or other wallpaper design parameters to a user for facilitating the creation and delivery of custom wallpaper. User options can include, but are not limited to, “About My Walls”, “Create Now”, “Measuring”, “Installation”, “For Your Business”, and “For Kids Only”. Typically, user options or other wallpaper design parameters provide a set of tools or parameters to a user for facilitating the creation and delivery of custom wallpaper. Other user options can provide administrative tools for a user to access a user account. A user can utilize a remote device and/or an associated input device to interact with the webpage in order to select a desired user option. For example, a user can utilize a touch screen at a kiosk to interact with a webpage of an Internet website. Each of the user interactions with the webpage can then be transmitted to one or more custom wallpaper creation program modules 102 for facilitating the creation and delivery of custom wallpaper.

Another example of a user option on the homepage 400 of an exemplary website for facilitating the creation and delivery of custom wallpaper can be a sign-in feature that requires a user to enter a user name and a password. If the user is a new user, then the sign-in feature permits the new user to create a new user name and password. If the user is a returning user, then the user may prompted to whether he or she wants to change or order previously stored wallpaper design samples.

FIG. 5 is a screen shot of a creation webpage 500 of a website that operates in conjunction with an exemplary embodiment of the present invention. If a user selects the option “Create Now” 404 from a homepage 400 as shown in FIG. 4, then one or more exemplary custom wallpaper creation program modules 102 can display a creation webpage 500 to present a pull-down menu 502 with one or more user options 504-510 related to creating custom wallpaper. User options related to creating custom wallpaper can include, but are not limited to, “By Room”, “By Theme”, “By Color” and “For Kids”. For example, a user can utilize a pull down menu 502 with one or more user options 504-510 or other wallpaper design parameters. By selecting a particular user option such as “By Room” 504, a user can select further user options related to designing wallpaper for a particular room in a house.

FIG. 6 is a screen shot of another creation webpage of a website that operates in conjunction with an exemplary embodiment of the present invention. If a user selects the user option “By Room” 504 from the webpage 500 as shown in FIG. 5, then one or more exemplary custom wallpaper creation program modules 102 can display another creation webpage 600 to present one or more user options 602-612 or other wallpaper design parameters. User options can include, but are not limited to, “Kitchen”, “Bedroom”, “Living Room”, “Kid's Room”, “Dining Room”, and “More Rooms”. For example, a user can select a particular user option such as “Kid's Room” 608 to obtain further options related to designing wallpaper for a “Kid's Room” or child's room.

FIG. 7 is a screen shot of another creation webpage of a website that operates in conjunction with an exemplary embodiment of the present invention. If a user selects the user option “Kid's Room” 608 from the webpage 600 as shown in FIG. 6, then one or more exemplary custom wallpaper creation program modules 102 can display another creation webpage 700 to present one or more pull-down menus 702, 704 and additional user options 706-718 for wallpaper design parameters. For example, a pull-down menu 702 for “Select Border Graphics” can provide multiple user options 706-718 for border graphics or other wallpaper design parameters. User options for border graphics can include, but are not limited to, “Animals”, “Toys”, “Patterns”, “Clowns”, “Outer Space”, and “For Boy's Room”, and “For Girl's Room”. If a user can selects a particular pull-down menu user option such as “Animals” 706, then a scrollable list 720 containing a variety of previously stored graphical elements 722-730 or other wallpaper design parameters can be displayed to the user via a display device or remote device. Additional samples for border graphics of previously completed wallpaper designs can be called by the user by selecting the user option “Some Samples” 732. Furthermore, composite wallpaper graphical elements 734-736 can be also displayed in the scrollable list 720 for selection by the user. Additional composite wallpaper graphical elements or other wallpaper design parameters may be accessible for viewing and selection by the user simply by accessing a carat 738 at the bottom of the scrollable list 720.

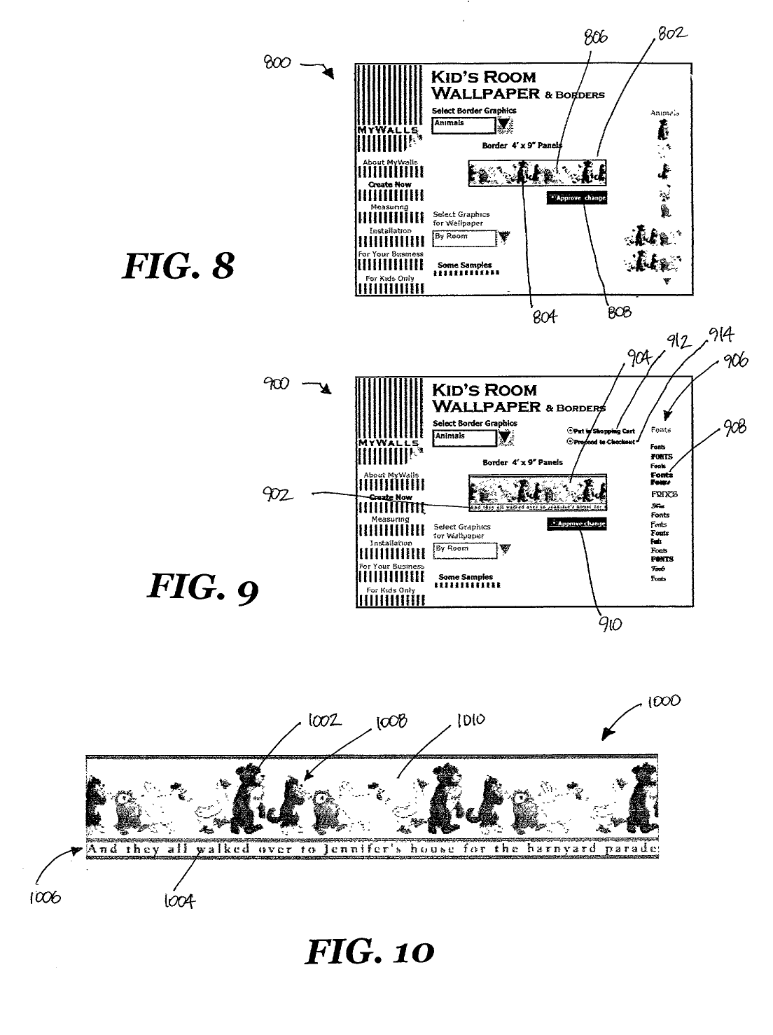

FIG. 8 is a screen shot of another creation webpage of a website that operates in conjunction with an exemplary embodiment of the present invention. Once a user selects wallpaper design parameters from the webpage 700 as shown in FIG. 7, then one or more exemplary custom wallpaper creation program modules 102 can display another creation webpage 800 to present a wallpaper design sample 802 that incorporates one or more wallpaper design parameters such as previously stored graphical elements 722-730, 734-736. For example, a wallpaper design sample 802 of a 4 foot by 9 inch border panel can be graphically displayed with individual graphic elements 804 and/or composite graphic elements 806 or other wallpaper design parameters can be displayed to a user on a display device or remote device. When the user has completed a sample wallpaper design, the user can approve the change simply by clicking on the button 808 labeled “Approve change”. Approving a change will store the wallpaper design sample 802 into the database 138 or other memory-type device for later retrieval. The design process described in HGs. 4-9 can be repeated as necessary until the user is satisfied with or otherwise completed designing one or more custom wallpaper design samples. Therefore, as described in FIGS. 4-9, when a user selects particular wallpaper design parameters for a wallpaper design sample 802, the user can then store each wallpaper design parameter or set of parameters as needed, and one or more of the custom wallpaper creation program modules 102 can prompt the user at each stage of the design process until a complete wallpaper design sample is created.

FIG. 9 is a screen shot of a creation webpage 900 of a website that operates in conjunction with an exemplary embodiment of the present invention. The custom wallpaper creation program module 102 can also prompt the user to add text 902 to a wallpaper design sample 904. A selection of fonts 906 can be displayed in a scrollable list 908 for the user's selection of a particular typeface or font. After selecting a particular font and text, the wallpaper design sample 902 is updated by the custom wallpaper creation program module 102 to reflect changes such as font and text changes made by the user. The user can then store the new wallpaper design sample 902 in the database 138 for later retrieval by selecting the button “Approve change” 910.

Once a user is satisfied with or otherwise completed designing custom wallpaper design samples as shown in FIGS. 4-9, then the user can proceed to checkout. A custom wallpaper creation program module 102 displays one or more checkout options such as “Put in Shopping Cart” 912 or “Proceed to Checkout” 914. If a user selects the checkout option “Put in Shopping Cart” 912, then the custom wallpaper creation program module 102 can prompt the user to create an additional wallpaper design sample, to complete the order and purchase the wallpaper design sample today, or store the wallpaper design sample for future purchase. For example, if the user has already created wallpaper, then the user is prompted to design a matching border. Alternatively, if the user has created a border, then the user is prompted to create matching wallpaper. Other types of wallpaper design elements or wallpaper design parameters can be prompted.

If a user selects the checkout option “Proceed to Checkout” 914 then the custom wallpaper creation program module 102 can prompt the user to complete a one or more webpages or forms querying the user about footage, dimensions, verification of designs and text. Furthermore, the user can be required to complete billing information, shipping information, and certify agreement to production disclaimers. Other types of transaction information can be prompted from the user upon checkout.

FIG. 10 is an illustration of a wallpaper design sample 1000 created by an exemplary embodiment of the present invention. The wallpaper design sample can include wallpaper design parameters such as graphic objects, designs, patterns and repeat patterns, border trim, backgrounds including background color and textures, photographic images, illustrations, clip art, fonts, text, typeface, colors, etc. For example, this particular wallpaper design sample 1000 includes a graphic object 1002, text 1004, a type of font 1006, color 1008, and background 1010. Other combinations of wallpaper design parameters and user-selected options or parameters can be compiled into a wallpaper design sample 1000 for printing by the present invention.

Alternative embodiments will become apparent to those skilled in the art to which the present invention pertains without departing from its spirit and scope. Accordingly, the scope of the present invention is defined by the appended claims rather than the foregoing description.

I claim:

1. A method for creating custom wallpaper comprising the steps:
storing a selection of wallpaper design parameters;
displaying a selection of wallpaper design parameters;
receiving a user selection of at least one design parameter;
displaying user-selected wallpaper design parameters;
storing user-selected wallpaper design parameters;
transmitting the user-selected wallpaper design parameters to a print device; and
printing a design characteristic corresponding to one or more user- selected wallpaper design parameters.

2. The method of claim 1 wherein the selection of wallpaper design parameters is stored in a database.

3. The method of claim I wherein the displaying a selection of wallpaper design parameters is performed by a remote device.

4. The method of claim 3 wherein the remote device consists of one of the following: a kiosk, a personal computer, a personal digital assistant.

5. The method of claim I wherein the step of storing user-selected wallpaper design parameters comprises the step of translating user-selected design parameters into an electronic format compatible for printing a corresponding design characteristic on a medium with a printing device.

6. The method of claim 1 further comprising:
determining whether a payment from the user is authorized; and
in response to determining that payment is not authorized,
receiving user financial information;
transmitting user financial information to a financial institution;
receiving feedback from the financial institution; and
authorizing a user transaction based upon feedback from the financial institution.

7. The method of claim 1 wherein a wallpaper design parameter consists of one of the following: color, text, font, typeface, border, background, trim, image, photo, illustration, texture, or pattern.

8. The method of claim 1 wherein each step can be executed in a networked computer environment.

9. A system for creating custom wallpaper comprising:
a custom wallpaper creation program module for
displaying a selection of wallpaper design parameters on a display device;
receiving a user selection of wallpaper design parameters via an input device;
displaying one or more selected wallpaper design parameters on the display device; and
a printing module for
receiving user selected wallpaper design parameters from the custom wallpaper creation program module;
formatting the wallpaper design parameters for printing a corresponding design characteristic on a sheet of wallpaper; and
printing a corresponding design characteristic on a medium.

10. The system of claim 9 wherein the custom wallpaper creation program module further comprises:
a database for
storing previously defined wallpaper design parameters for selection by a user;
storing user-selected wallpaper design parameters;
transmitting user-selected wallpaper design parameters to the printing module.

11. The system of claim 10 wherein the printing module is further operable for:
receiving user-selected wallpaper design parameters from the database.

12. The system of claim 10 wherein the printing module comprises a digital printing device.

13. The system of claim 9 wherein the custom wallpaper creation program module is stored on a server in communication with a distributed computer network.

14. The system of claim 9 wherein the custom wallpaper creation program module is stored on a remote device.

15. The system of claim 14 wherein the remote device consists of one of the following: a kiosk, a personal computer, a personal digital assistant.

16. The system of claim 9 wherein the display device is connected to a remote device comprising
a processor operable for executing an operating system and for executing a browser program to communicate with the custom wallpaper creation program module.

17. The system of claim 10 wherein the database is stored on a server in communication with a distributed computer network.

18. The system of claim 10 wherein the database is further operable for
storing user-related data;
storing a plurality of custom wallpaper templates,
storing a plurality of wallpaper design parameters with corresponding design characteristics; and
storing finalized custom wallpaper designs.

19. The system of claim 9 wherein the custom wallpaper creation program module is further operable for:
receiving user financial information;
transmitting user financial information to a financial institution;
receiving user-specific information from the financial institution; and
authorizing a user transaction based upon user financial information.

20. A computer-readable medium with computer executable instructions for creating custom wallpaper in a networked computer environment comprising the steps:
storing a selection of wallpaper design parameters in a database;
displaying a selection of wallpaper design parameters;
receiving a user selection of at least one design parameter from a remote device;
displaying user-selected wallpaper design parameters;
storing user-selected wallpaper design parameters;
transmitting the user-selected wallpaper design parameters to a print device; and
printing a design characteristic corresponding to one or more user-selected wallpaper design parameters.

21. The computer-readable medium of claim 20 wherein the remote device consists of at least one of the following: a kiosk, a personal computer, a personal digital assistant.

22. The computer-readable medium of claim 20 wherein the step of storing user-selected wallpaper design parameters further comprises the step:
translating user-selected design parameters into an electronic format compatible for printing a corresponding design characteristic on a medium with a printing device.

23. The computer-readable medium of claim 20 further comprising steps:
determining whether a payment from the user is authorized; and in response to determining that payment is not authorized,
receiving user financial information;
transmitting user financial information to a financial institution;
receiving feedback from the financial institution; and
authorizing a user transaction based upon feedback from the financial institution.
